(19) United States
(12) Patent Application Publication
(10) Pub. No.: US 2002/0127474 A1
(43) Pub. Date: Sep. 12, 2002

(54) Proton-selective conducting membranes

(75) Inventors: Niles A. Fleischer, Rehovot (IL); Joost Manassen, Rehovot (IL); Charles Linder, Rehovot (IL); Nitsa Mazor, Yavne (IL); Arieh Meitav, Rishon Le-Zion (IL); Ilia Yakupov, Rehovot (IL)

Correspondence Address: DR. MARK FRIEDMAN LTD., c/o Bill Polkinghorn- Discovery Dispatch, 9003 Florin Way, Upper Marlboro, MD, 20772, US

(73) Assignee: E.C.R.-ELECTRO-CHEMICAL RESEARCH LTD.

(21) Appl. No.: 09/756,133

(22) Filed: Jan. 9, 2001

(51) Int. Cl. H01M 10/40; C08J 5/22; H01M 8/10; H01M 4/50; H01M 4/38; H01G 9/038

(52) U.S. Cl. 429/309; 521/27; 429/33; 429/224; 429/218.1; 361/502; 429/316

(57) ABSTRACT

A membrane comprising: (a) a hydrophobic matrix polymer, and (b) a hydrophilic non-ionic polymer, wherein the hydrophobic polymer and the hydrophilic polymer are disposed so as to form a dense selectively proton-conducting membrane. The microstructure of such a membrane can be tailored to specific functionality requirements, such as proton conductivity vs. proton selectivity, and selectivity to particular species.

### FIELD AND BACKGROUND OF THE INVENTION

The present invention relates to electrochemical systems used as power sources for storage and release of electrical energy. In particular, the invention relates to electrochemical systems such as, but not limited to, batteries, capacitors and fuel cells. Even more particularly, the present invention relates to electrochemical systems that effect the conversion of chemical energy to electrical energy at ambient temperatures by using a proton-selective, non-liquid electrolyte membrane positioned between the electrodes.

Electrochemical systems containing liquid electrolytes are well known in the art. Such systems characteristically have excellent proton-transfer rates at ambient and even sub-ambient temperatures. The disadvantages of such systems, which are also well known, include: tendency to leak, requirement of additional cell elements to maintain the absorption of liquid between the electrodes, environmental and safety risks due to the corrosivity and/or caustic nature of typical aqueous electrolytes or the flammability of various organic solvents.

Further disadvantages stem from the constraints imposed by liquid electrolyte systems on cell design. Usually, liquid electrolyte electrochemical systems are built as individual cells in order to contain the liquid between the electrodes. Since in many applications, an operating voltage greater than that provided by a single cell is required, a plurality of cells needs to be connected in series to achieve the target voltage. A multiple arrangement of individually packaged cells leads to a large pack volume and reduces the volumetric energy density of the pack relative to that of the individual cell or to that of alternative arrangements of assembling a plurality of cells within a single package.

Solid electrolyte membrane systems are also well known. State-of-the-art proton exchange membrane (PEM) materials may be divided into the following groups: 1) completely fluorinated (perfluorinated) or 2) partially fluorinated or 3) non-fluorinated. They may be further characterized as a) free self-supporting films, b) films mechanically re-enforced with an embedded net, c) composite films of a thin proton conducting layer on a porous support or d) a porous support impregnated with the proton conducting material. Although most PEMs feature flat configurations, spiral, wound, tubular and hollow fiber configurations have been disclosed.

Many commercial PEMs are cation exchange perfluorinated films based on copolymers of tetrafluoroethylene and perfluorinated vinyl ethers with terminal sulfonic acid functional groups having the following structure:

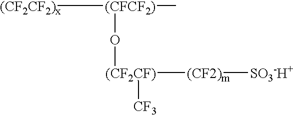

Membranes based on partially fluorinated polymers, alpha-substituted and non-substituted trifluorinated polystyrenes are also manufactured.

The patent and technical literature, however, report a vast amount of work on other materials. These may be divided into the following categories:

1) Cation or anion exchange including a single polymer (which may or may not be cross-linked) forming the matrix with proton conductivity.

2) Ion exchange polymers (in many cases cation exchange but also anion exchange) in a non-ionic polymer matrix, including blends, grafted films and porous materials of one polymer impregnated with proton conducting ionic polymers of another class.

3) Hybrid organic and inorganic material combinations that include dispersions of inorganic materials (down to nano-sized particles) in a polymer matrix, polymers containing both inorganic and organic groups and an inorganic matrix with ionic organic groups for proton conduction.

4) Inorganic PEMs

5) Composite layers of different polymers

6) Ionomeric matrices swollen with a strong acid for proton conductivity

7) Self assembled layers

1. Cation or Anion Exchange Polymers Forming Proton Conductive Matrix

Some commercial PEMs are perfluoroinated based on the copolymer of tetrafluoroethylene and perfluoroinated sulfonic acid. There are for example proton conducting membranes made from other polymeric materials such as sulfonated polyphenylene sulfides, polyetherketones, polysulfones and polyethersulfones, polyphenylquinoxiline, sulfonated block polymers (polystyrene-ethyelene/butylene-styrene which forms sulfonated domains such as sulfonated Kraton™, a styrene block polymer containing polybutadiene or polyisoprene. There are variations of the sulfonation procedure in which the monomer of polysulfone is first sulfonated and the sulfonic groups are on the sulfone moiety rather than on the aromatic ether. Cation exchange membranes have been made from sulfonated and sulfonated polysulfonates and polyether sulfones, and cross-linking to enhance stability has been carried out by cross-linking through sulfur groups and by disproportionation of sulfinic groups or by alkination of sulfinate groups.

In general, PEM membranes are cation exchangers based on sulfonic acid. There are however numerous examples in the patent and technical literature of cation exchange PEM with other groups (e.g., sulfonimides, —PO₂H₂, —CH₂PO₃H₂, —COOH, —OSO₃H, —OPO₂H₂, —OPO₃H₂, —OArSO₃H) and anion exchange membranes based on amino and quaternary ammoniums (the alkyl chains on the nitrogen may or may not be fluorinated). The anion exchange membranes appear to be good candidates for limiting fuel crossover in methanol fuel cells.

Materials in which phosphonic groups replace sulfonic groups on poly(trifluorostyrene) ionomers and on polysulfone and polyethersulfone or polypheneylene sulfides have been studied.

In an example of different groups on a chain, aromatic polymers are nitrated and then sulfonated to make cation exchange membranes. The nitro groups may be optionally reduced to amines.

The sulfonimide is a very strong Bronsted acid and the strongest acid in the gas phase. It has been investigated as an alternative to sulfonic groups. For example, polymers of the following structure may be cast into PEM membranes:

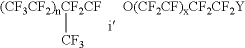

wherein Y=—SO₂N(H)SO₂CF₃ for sulfonimides and Y=—SO₃H for the commercial DuPont® product (Nafion®).

2. Ion Exchange Polymers (in many cases cation exchange but also anion exchange) in a Non-ionic Polymer Matrix

This category includes blends, grafted films and porous materials of one polymer impregnated with proton conducting polymers of another class, e.g., membranes made from blends of polymers such as a polyvinylidene fluoride (PVDF) matrix with sulfonated polyphenylene oxide or polystyrene sulfonic acid in a PVDF matrix. Examples of grafted membranes include polytetrafluoroethylene or polyethylene-co-tetrafluoroethylene or PVDF with grafted styrene or polystyrene-divinyl benzene which is subsequently sulfonated. Other examples that belong to this group are grafted sulfonated beta trifluorostyrene in a PTFE-HFP matrix, and polyvinyl alcohol with sulfonated polystyrene.

Examples of thin membranes made by plasma polymerization are perfluorinated compounds such as fluorobenzene, which is polymerized to produce a polymerized film, in a first step, which is followed by sulfonation, phosphorylation or carboxylation. Another example is plasma polymerization of vinyl phosphonic acid with tetrafluoroethylene to form thin proton conducting films on substrates, which serve as a matrix for the electrode materials.

Microporous membranes (e.g., commercially available microporous membranes made of polycarbonate such as Nucleopore®) have been filled with proton conducting polymers. The pores of other porous membranes have been filled with proton conducting polymers containing sulfonated and many other ionic groups such as —PO₂H₂, —CH₂PO₃H₂, —COOH, —OSO₃H, —OPO₂H₂, —OPO₃H₂, —OArSO₃H, and quaternary ammoniums. Materials used to make the porous membrane are polyaryl sulfide or sulfone membranes whose pores may be filled with the DuPont polymer Nafion®.

Another example of a blended membrane is that of sulfonated polyaromantics with polyoxyethylene, wherein the latter acts as a matrix for proton transfer instead of water.

Porous PVDF films have been made and acrylic acid graft polymerized into the pores to form acrylic acid containing pores.

In yet another case blends of both acid-base ionomers are used. For example, the acid components may be materials such as sulfonated polyetherketone and sulfonated polysulfone. The basic component may be materials such as amino-PSu derivatives or polyvinyl pyridine and benzimidazole.

3. Hybrid Membranes Combining Organic and Inorganic Materials

This category includes dispersions of inorganic materials (down to nano-sized particles) in a polymer matrix, polymers containing both inorganic and organic groups and inorganic matrix with ionic organic groups for proton conduction.

Examples include:

Hybrid organic/inorganic PEMs made of a matrix, to which inorganic (if the matrix is organic) and organic (if the matrix is inorganic) moieties are covalently or ionically bonded.

Other examples are zirconium sulfoarylphosphonates, inorganic silicates with organic moieties containing sulfonic groups, sulfonated polyphosphazenes (poly(3-methyl phenoxy) phosphazenes sulfonated with SO₃ and then crosslinked with ultraviolet radiation.

An additional example is alkoxy silanes, which form an inorganic silicate backbone, to which are attached organic pendants containing sulfonic groups formed from these alkoxy silanes. In another example, membranes are formed from inorganic silsequionaxe bound to polyoxyethylene through urethane bonds.

Other types of hybrid organic/inorganic PEMs are a polymer matrix such as Nafion®, PVDF or sulfonated polyphenyl oxide, polysulfones and polyether ketones with proton conducting inorganic particles such as zirconium oxide, zirconium phosphate, titanium oxide, aluminum oxide, silica, heteropolyacids[e.g., phosphoatoantimonic acid]).

Another example in this group is zirconyl phosphate precipitated in the pores of a membrane.

4. Inorganic PEMs

Examples of inorganic PEMs are a porous ceramic matrix impregnated with zirconium oxide, polyphosphates or polyantinomic acids.

Yet another group of examples are nanoporous ceramic membranes made from at least one of the group consisting of SiO₂, TiO₂, Al₂O₃, wherein the nanoporous membrane is produced by the sol-gel method of preparing membranes.

5. Composite Layers of Different Polymers

Examples of PEMs formed from composite layers of different polymers are:

sulfonated polybenzimidazole layer on a Nafion®0 layer. The objective is to reduce methanol cross over.

PEM on a porous support layer on one or both sides of the PEM; for use in direct methanol fuel cells.

bi-layer or tri-layer ion exchange composite membranes composed of sulfonic fluoropolymer in both core and surface layers.

plasma polymerization of monomers to form PEM on aerogel electrode layers.

plasma polymerized PTFE film on sulfonated PTFE (polytetrafluoroethylene).

6. Ionomeric Matrix Swollen with a Strong Acid for Proton Conductivity

Examples are:

PEMs where the matrix is impregnated with a strong acid that conducts the protons. For example the acid is phosphoric acid and the matrix is chosen from polyheterocyclics such as polybenzimidazole, polyoxazoles, polypyridines, polypyrimidines, polyimidazoles, polythiazoles, polybenzoxazoles, polyoxadiazoles, polyquinolines that may also contain sulfonic phosphonic or boronic acid groups.

sulfonated polyetherketones, polyethersulfones, and polyphenylquinoxalines are used as the matrix of a strong acid. The doping is with at least 200 mole % phosphoric acid.

sulfonated PEEK, PES, and polyphenylquinoxaline (PPQ) impregnated with concentrated phosphoric acid.

films of polysilamine swollen with strong acids.

7. Self Assembled Layers

Surfactants with colloidal crystals have been used to form self-assembled layers that are being tested in fuel cells.

Crystal like lattice of layers of muconate anions (reactive dienes with carboxalate group on either end) sandwiched between layers of alkylammonium cations. When exposed to ultraviolet light the muconate anions polyerize to generate a molecule thick polymer sheet. Exposing the synthetic clay to acid removes the ammonium cations freeing the sheets, which can then be joined together with other ammonium cations.

Numerous studies have shown that in fuel cell operation, the membrane life time goes in the following order:

completely fluorinated>>partially fluorinated>>>non-fluorinated

In spite of the obvious chemical superiority of the perfluorinated materials, work is being carried out on all types of materials because of the high cost of the perfluorinated materials, and with the objective of improving stability in each category with new materials, or combinations of existing materials. There is also the expectation that there may be sizable applications for all types of PEMs with varying degrees of stability and life time.

Although much has been written in the literature about proton conductors, including both organic and inorganic types, little attention has been given to proton specificity. Thus, many so-called proton conductors suffer from a low proton specificity, allowing other ions (cations and anions), and other species to pass through the membrane.

It is evident, therefore, that a proper evaluation of proton conductors must take into account proton specificity, which can be divided into several aspects:

specificity for conducting protons versus other cations;

specificity for conducting protons versus anions;

specificity for conducting protons versus neutral species;

specificity for protons versus gases.

For example: proton-conducting specificity versus neutral species is of great importance in fuel cells, which have characteristically high current densities that are carried by protons in acidic type cells, and in which the transfer of hydrogen or methanol or other fuels through the membrane is known to be detrimental.

Various kinds of ion specific membranes are known. In electrochemical systems in which a cathodic and an anodic compartment are separated from each other by a membrane, it is particularly advantageous to have a membrane that selectively transfers protons. In such electrochemical systems, every movement of electrons between the electrodes has to be accompanied by an equalization of charge by the passing of a charged species through the membrane. It is known that protons generally provide the best conductivity relative to all other ions in aqueous solutions, in polar liquid solutions, and in other protonic or proton-containing liquid solutions. Hence, it is highly desirable that the above-mentioned charge-equalization occurs solely through the transfer of protons.

Selective proton exchange membranes are also of special importance for those systems in which a part of the redox-active species is dissolved in the cathode and/or anode compartment. Ionic mixing in such a system leads to the inactivation of the system. Examples of this kind of system include certain types of rechargeable batteries, redox batteries and sensors.

Although other types of electrochemical systems such as fuel cells, electrochemical capacitors, pseudo-capacitors and photo-electrochemical cells may use membranes or separators that transfer other ions in addition to protons, some undesired self-discharge reactions that occur by shuttling of ionic species through the membrane separator may be prevented by the use of a proton selective membrane.

In addition to poor proton specificity, a major disadvantage of known solid electrolytes, such as polyethylene based electrolytes and β-alumina based electrolytes, is poor conductivity at ambient temperatures, which generally limits the use of solid electrolytes to warm or high temperature cells in which the operating temperature is at least about 80° C. and certainly no less than about 60° C. Various fluorinated sulfonic acids having the form:

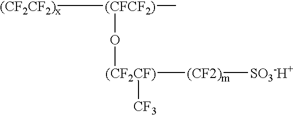

wherein:

n=1 and m=2 for Dupont Nafion®;

n=0 and m=2 for a Dow membrane; and

n=0-2 and m=2-5 for Asahi Chemicals membranes,

are used in cells operating at temperatures of at least 90° C.-95° C. in order to have sufficient conductivity.

Thus, while proton-conducting solid electrolyte membranes exist, they do not have the requisite proton specificity for many applications, and are fundamentally inappropriate for operation at ambient conditions. It must be further emphasized that Nafion® and other known commercial perfluorinated solid electrolyte membranes are extremely expensive. Nafion®, in particular, requires treatment, and must be stored in a humid environment.

There is therefore a need for, and it would be very advantageous to have, a proton-conducting solid electrolyte membrane that is more efficient and more proton-specific than known membranes, and that provides such efficient and proton-specific operation at ambient and sub-ambient temperatures. It would be an additional advantage to have a PEM that was selective even at elevated temperatures. It would be of further advantage to have a proton-conducting solid electrolyte membrane that is non-toxic, robust, easily manufactured, and produced from inexpensive raw materials.

### SUMMARY OF THE INVENTION

### Summary will be Updated and Expanded Once Claims have been Finalized

The present invention is of a proton-conducting, proton-specific, solid electrolyte membrane for use in various kinds of electrochemical systems including batteries, fuel cells, and capacitors. The inventive membrane enables efficient operation at ambient temperatures, and is particularly suitable for various portable applications.

In another embodiment the inventive membranes enable efficient selective operation at elevated temperature.

We have surprisingly found that certain combinations of highly polar polymers (that are in some cases water-soluble), being to a certain degree compatible with relatively hydrophobic polymers, can synergistically form films having particularly selective proton conducting properties. In effect, these films or membranes, under conditions of use, enable the preferential transfer of protons relative to cations, anions and neutral substances such as water, methanol and ethanol, and gases such as air, oxygen, hydrogen and nitrogen. It has also been found that such membranes can be used to form useful rechargeable batteries, super capacitors and redox batteries, and furthermore, that these batteries and electrochemical devices can be of an ultra thin and compact form and feature a high charge density.

The inventive membranes were also found to be very useful in making proton exchange fuel cells which consume fuels such as hydrogen gas, methane, methanol vapor or aqueous methanol. Because the inventive membranes contain a matrix element and a proton conducting element, the matrix can be selected to substantially inhibit the transfer of hydrogen gas or other fuels through the membrane.

Thus, according to the teachings of the present invention there is provided a membrane including: (a) a hydrophobic matrix polymer and (b) a hydrophilic non-ionic polymer, wherein the hydrophobic polymer and the hydrophilic polymer form together a selectively proton-conducting membrane.

According to another aspect of the present invention there is provided a membrane including: (a) a hydrophobic matrix polymer, and (b) a hydrophilic non-ionic polymer, wherein the hydrophobic polymer and the hydrophilic polymer form together a consolidated selectively proton-conducting membrane.

According to yet another aspect of the present invention there is provided an electrochemical system having an electrochemical cell including: (a) an anode; (b) a cathode, and (c) a selectively proton-conducting membrane disposed between, and being in communication with, the anode and the cathode, the membrane containing: (i) a hydrophobic matrix polymer and (ii) a hydrophilic non-ionic polymer.

According to yet another aspect of the present invention there is provided a method of operating an electrochemical cell, the method including the steps of: (a) providing an electrochemical cell including: (i) an anode; (ii) a cathode, and (iii) a consolidated selectively proton-conducting membrane disposed between, and being in communication with, the anode and the cathode; (b) transporting protons across the membrane, between the anode and the cathode, and (c) substantially obstructing at least one species other than protons from passing through the membrane.

According to further features in the described preferred embodiments, the hydrophobic polymer and the hydrophilic polymer are distributed in a substantially homogeneous blend.

According to still further features in the described preferred embodiments, the hydrophobic polymer and the hydrophilic polymer organize into at least two phases.

According to still further features in the described preferred embodiments, the hydrophobic polymer and the hydrophilic polymer organize into a miscible phase.

According to still further features in the described preferred embodiments, the proton-conducting membrane includes at least two non-miscible phases.

According to still further features in the described preferred embodiments, the selectively proton-conducting membrane is substantially a barrier to cationic species other than protons.

According to still further features in the described preferred embodiments, the selectively proton-conducting membrane is substantially a barrier to anionic species.

According to still further features in the described preferred embodiments, the selectively proton-conducting membrane is substantially a barrier to neutral species.

According to still further features in the described preferred embodiments, the selectively proton-conducting membrane is substantially a barrier to gaseous species.

According to still further features in the described preferred embodiments, the selectively proton-conducting membrane is substantially a barrier to organic species.

According to still further features in the described preferred embodiments, the selectively proton-conducting membrane is substantially a barrier to anionic species, neutral species, gaseous species, organic species, and cationic species other than protons.

According to still further features in the described preferred embodiments, the selectively proton-conducting membrane is substantially a barrier to water.

According to still further features in the described preferred embodiments, the hydrophobic polymer includes a first functional group and wherein the hydrophilic polymer includes a second functional group that are configured by an interaction to form a conduit for the selective conduction of protons.

According to still further features in the described preferred embodiments, the above-mentioned interaction is selected from the group consisting of H-bonding interactions, electrostatic interactions, pi orbital interactions, dipole-dipole interactions, dipole induced dipole interactions, charge transfer interactions and an interaction representing a sum of a mutual repulsive force between dissimilar segments within one of the polymers and a repulsive source between the polymers.

According to still further features in the described preferred embodiments, the first functional group is selected from at least one of the groups consisting of halide, nitro, sulfone, nitrile, ether, carbonyl, benzyl, aromatic, and heterocyclic aromatic groups.

According to still further features in the described preferred embodiments, the second functional group is selected from at least one of the groups consisting of amide, lactam, Shiff base, hydroxyl amine, ether, phosphonate, heterocyclic containing a cyclic nitrogen atom, heterocyclic containing a cyclic oxygen atom, and heterocyclic containing a cyclic sulfur atom.

According to still further features in the described preferred embodiments, the hydrophobic matrix polymer is a fluoro-polymer selected from the group consisting of polymer, copolymer, and terpolymer.

According to still further features in the described preferred embodiments, the hydrophilic polymer has at least one functional group selected from the group consisting of amides, lactams, and amines.

According to still further features in the described preferred embodiments, the hydrophobic polymer is selected from the group consisting of polyvinylidene fluoride (PVDF), copolymers thereof, terpolymers thereof, polyphenylene oxide, polysulfone, polyether sulfone, polyphenyl sulfone, combinations thereof, and derivatives thereof.

According to still further features in the described preferred embodiments, the hydrophilic polymer is selected from the group consisting of polyvinylpyrrolidone, copolymers of polyvinylpyrrolidone, poly (2-methyl-2-oxazoline) polymers, poly (2-ethyl-2-oxazoline) polymers, combinations thereof, and derivatives thereof.

According to still further features in the described preferred embodiments, the hydrophobic polymer is selected from the group consisting of polyvinylidene fluoride and polyvinylidene fluoride co-hexafluoropropylene, and wherein the hydrophilic polymer is selected from the group consisting of polyvinylpyrrolidone and poly(2-ethyl-2-oxazoline).

According to still further features in the described preferred embodiments, the membrane further includes: (c) a porous support layer for supporting the selectively proton-conducting membrane.

According to still further features in the described preferred embodiments, the selectively proton-conducting membrane is free-standing.

According to still further features in the described preferred embodiments, the selectively proton-conducting membrane is a single membrane, and is attached to an embedded net.

According to still further features in the described preferred embodiments, the selectively proton-conducting membrane is a single membrane, and is attached to a non-woven material.

According to still further features in the described preferred embodiments, the selectively proton-conducting membrane is a single membrane, and is attached to a randomly structured material.

According to still further features in the described preferred embodiments, the selectively proton-conducting membrane is a layer in a composite membrane having a layer of a cation exchange membrane.

According to still further features in the described preferred embodiments, the selectively proton-conducting membrane is a layer in a composite membrane having a layer of a proton-conducting anion exchange membrane.

According to still further features in the described preferred embodiments, the composite membrane includes a layer of a proton-conducting anion exchange membrane and a cation exchange membrane.

The above-mentioned features have been found to improve selectivity and to promote the stability of the inventive membrane

According to still further features in the described preferred embodiments, the membrane is included in the above-described electrochemical system, wherein the anode includes at least one material having a metal whose cation can assume at least two different non-zero oxidation numbers, wherein the cathode includes a compound forming an electrochemical couple with the anode, and wherein the cell is inherently active in initiation of discharge under ambient conditions.

According to still further features in the described preferred embodiments, the anode includes an organic compound that is a source of protons during discharge, and the cathode includes a compound which forms an electrochemical couple with the anode.

According to still further features in the described preferred embodiments, the electrochemical cell is a fuel cell.

According to still further features in the described preferred embodiments, the fuel cell contains an anodic fuel including an organic liquid.

According to still further features in the described preferred embodiments, the fuel cell contains an anodic fuel including hydrogen.

According to still further features in the described preferred embodiments, the anode forms a first layer, the cathode forms a second layer, and the selectively proton-conducting membrane is structured as a layer in an integrated assembly that further includes at least one of the first and second layers affixed to the membrane.

According to still further features in the described preferred embodiments, the anode contains a compound of tin.

According to still further features in the described preferred embodiments, the cathode contains a compound of manganese.

According to still further features in the described preferred embodiments, the anode contains a compound of tin, and the cathode contains a compound of manganese.

According to still further features in the described preferred embodiments, the electrochemical cell is a rechargeable battery.

According to still further features in the described preferred embodiments, the rechargeable battery has a thickness of about 0.2 mm to about 8 mm.

According to still further features in the described preferred embodiments, the anode and the cathode each have a thickness of about 30 microns to about 600 microns.

According to still further features in the described preferred embodiments, the battery is disposed in a smart card.

According to still further features in the described preferred embodiments, the battery is disposed in an RF tag.

According to still further features in the described preferred embodiments, the electrochemical cell is an electrochemical double layer capacitor.

According to still further features in the described preferred embodiments, the double layer capacitor has a plurality of electrodes, each of the electrodes having a thickness of about 30 microns to about 300 microns.

According to still further features in the described preferred embodiments, the double layer capacitor has a plurality of electrodes, wherein at least one of the electrodes includes a high surface area carbon material and a protonic medium selected from the group of materials consisting of water, aqueous acid solutions, sulfonic acids, compounds having at least one alcohol group, and combinations thereof.

According to still further features in the described preferred embodiments, the double layer capacitor has a thickness of about 0.2 mm to about 7 mm.

According to still further features in the described preferred embodiments, the electrochemical cell is a pseudo-capacitor.

According to still further features in the described preferred embodiments, the electrochemical cell is a non-rechargeable battery.

According to still further features in the described preferred embodiments, the hydrophobic matrix polymer is PVDF, and the hydrophilic non-ionic polymer is PVP, and the membrane contains between 57% and 67% PVDF and between 33% and 43% PVP.

According to still further features in the described preferred embodiments, the hydrophobic matrix polymer is PVDF, the hydrophilic non-ionic polymer is PVP, and the membrane contains a PVDF to PVP weight ratio of between 1.32 to 1 and 2.03 to 1.

According to still further features in the described preferred embodiments, the hydrophobic matrix polymer is PVDF-HFP, the hydrophilic non-ionic polymer is PVP, and the membrane contains between 57% and 67% PVDF-HFP, and between 33% and 43% PVP.

According to still further features in the described preferred embodiments, the hydrophobic matrix polymer is PVDF-HFP, the hydrophilic non-ionic polymer is PVP, and the membrane contains a PVDF-HFP to PVP weight ratio of between 1.32 to 1 and 2.03 to 1.

According to still further features in the described preferred embodiments, the hydrophobic matrix polymer is PVDF, the hydrophilic non-ionic polymer is PVP, and the membrane contains between 25% and 33% PVDF, and between 67% and 75% PVP.

According to still further features in the described preferred embodiments, the hydrophobic matrix polymer is PVDF, the hydrophilic non-ionic polymer is PVP, and the membrane contains a PVDF to PVP weight ratio of between 0.33 to 1 and 0.50 to 1.

According to still further features in the described preferred embodiments, the hydrophobic matrix polymer is PVDF-HFP, the hydrophilic non-ionic polymer is PVP, and the membrane contains between 25% and 33% PVDF-HFP, and between 67% and 75% PVP.

According to still further features in the described preferred embodiments, the hydrophobic matrix polymer is PVDF-HFP, the hydrophilic non-ionic polymer is PVP, and the membrane contains a PVDF-HFP to PVP weight ratio of between 0.33 to 1 and 0.50 to 1.

According to yet another aspect of the present invention there is provided a method of producing a membrane, including the steps of: (a) providing: (i) a hydrophobic matrix polymer; (ii) a hydrophilic non-ionic polymer, and (iii) at least one common solvent for the hydrophobic matrix polymer and the hydrophilic non-ionic polymer; (b) dissolving in the at least one common solvent, the hydrophobic matrix polymer and the hydrophilic non-ionic polymer, to produce a solution, and (c) treating the solution to produce a consolidated selectively proton-conducting membrane.

According to further features in the described preferred embodiments, the treating includes casting the solution on a substrate.

According to further features in the described preferred embodiments, the treating includes coating the solution on a porous substrate support.

According to further features in the described preferred embodiments, the treating further includes removing the solvent and removing the consolidated selectively proton-conducting membrane from the substrate.

According to further features in the described preferred embodiments, the treating further includes removing the solvent and removing the consolidated selectively proton-conducting membrane from the substrate.

According to further features in the described preferred embodiments, the porous support is asymmetric.

According to further features in the described preferred embodiments, the porous support is isotropic.

According to further features in the described preferred embodiments, the treating includes casting the solution on an ion exchange membrane, and removing the solvent, thereby producing a mosaic membrane including a selective proton conducting film on an ionic exchange membrane.

According to further features in the described preferred embodiments, the treating includes coating the solution on an ion exchange membrane, and removing the solvent, thereby producing a mosaic membrane including a selective proton conducting film on an ionic exchange membrane.

According to further features in the described preferred embodiments, the method of production further includes sandwiching the selective proton conducting film between the ionic exchange membrane and a stratum selected from the group consisting of cation exchange membrane, anion exchange membrane, and microporous support.

The proton-conducting solid electrolyte membrane of the present invention successfully addresses the numerous deficiencies exhibited by solid electrolyte membranes of the prior-art. Consequently, the inventive solid electrolyte membrane enables various kinds of electrochemical systems to operate at ambient and sub-ambient temperatures, as well as at elevated temperatures and in a more proton-specific, efficient, environmentally-friendly, robust and inexpensive fashion than known heretofore.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of a sub-assembly of an electrochemical double layer capacitor;

FIG. 2 depicts a multi-celled electrochemical double layer capacitor as formed by utilizing sub-assemblies of the type described in FIG. 1;

FIG. 3 provides a schematic, cross-sectional view of a battery utilizing a membrane according to the present invention;

FIG. 4 illustrates some basic components of a fuel cell utilizing a membrane according to the present invention.

### DESCRIPTION OF THE PREFERRED EMBODIMENTS

The present invention is of a proton-conducting, proton-specific, solid electrolyte membrane for use in various kinds of electrochemical systems including batteries, fuel cells, and capacitors. The inventive membrane enables efficient operation at ambient temperatures, and is particularly suitable for various portable applications.

This invention also relates to the use of the proton-selective conducting membrane in systems for electrochemical storage and release of electrical energy. In particular, the present invention relates to electrochemical systems such as, but not limited to, rechargeable batteries, non-rechargeable batteries, so called double-layer capacitors, so called pseudo-capacitors, and fuel cells. These systems differ in their mechanisms used for storage of energy and conversion of chemical energy into electrical energy.

In batteries, stored chemical energy is converted into electrical energy almost entirely via charge transfer reaction of active materials of the anode and cathode. These reactions occur mainly in the electrode bulk. The double layer that exists at the surface of the electrodes contributes only a very minor amount to the total stored energy. In rechargeable batteries, these charge transfer reactions are reversible to at least a very large extent.. In non-rechargeable batteries, the cells are built with active materials in the charged state and the discharge reaction is essentially non-reversible.

In so called double-layer capacitors, also referred to sometimes as super capacitors or electrochemical capacitors, the electrodes are made of materials that essentially do not participate in charge transfer reactions and so basically all of the energy is stored in the double layer at the surface of the electrodes.

So called pseudo-capacitors, also referred to sometimes as batcaps, have properties that can be characterized as intermediate between those of a rechargeable battery and double-layer capacitors. Reducing the thickness of a rechargeable battery can result in very thin electrodes. These electrodes contain active material that can participate in charge transfer reactions. The electrode thickness can be reduced to such an extent that the ratio of electrode bulk to electrode area is diminished. When high currents are used in the operation of such a thin electrochemical cell the charge transfer reactions occur mainly at the surface of the electrodes and the cell can be considered a pseudo-capacitor. Since such surface charge transfer reactions tend to release more energy than a double layer discharge, a pseudo-capacitor has a higher energy density than a double-layer capacitor but a lower energy density than a conventional rechargeable battery.

A fuel cell converts chemical energy to electrical energy in much the same way as a battery does. However the amount of active material in a fuel cell is not limited as it is in a battery. The amount of active material in a battery is defined by the amount of active material in the electrodes that are used for building the cells. In contrast, in a fuel cell, the active materials can be fed to the electrodes, the electrodes can be replenished, and/or the active materials, sometimes referred to as fuels, are fed to the electrodes in a stream or a flow system. At the cathode, the fuel can be a material selected from the group of air, oxygen, or other similar material. At the anode, the fuel can be a material selected from the group of hydrogen, organic materials like methanol and reformed methanol, and inorganic materials like zinc. The fuel can be used in the essentially pure form or combined with a second medium or a carrier. For instance, the methanol can be used as a solution in water or acid, like sulfuric acid.

As electronic devices and other electrical apparatuses become increasingly more portable and compact, advances must also be made in the sources of power used to operate such devices. As is often the case, the size of the electrochemical power source is a critical factor in determining the size of the electronic device that it is intended to operate. In many electrochemical systems the electrodes are separated by a liquid solution. In the solution, referred to as an electrolyte, ions can move freely. It is not, however, convenient to have a liquid present within an electrochemical system, especially if it is very thin or small. Liquids may leak form the cell, they may freeze, they may contribute to a high vapor pressure within the cell casing leading to rupture or separation between component layers, and many liquids are either corrosive, caustic, acidic, flammable, or some combination of these.

It is therefore desirable to provide an ultra-thin energy storage device, such as but not limited to, rechargeable batteries, non-rechargeable batteries, so called double-layer capacitors, so called pseudo-capacitors, and fuel cells, of the type that use membranes of the type of this invention for various applications.

Examples of applications of rechargeable, and even non-rechargeable, batteries, double-layer capacitors, and/or pseudo-capacitors, of the type of this invention, are, but not limited to, smart cards, RF tags, RF labels, bio-medical drug deliver patches, and smart pens. As a non-limiting example, an ISO standard smart card has a nominal thickness of 0.76 mm. Some cards may be up to 3 mm-5 mm thick. Thus, in applying a battery or a capacitor of the present invention to such thin smart cards, the thickness must be several mm or less. Preferably, the thickness is less than 1 mm, and for the case of an ISO standard smart card, the thickness should be less than 0.76 mm, and preferably about 0.5 mm thick. Since it is difficult to make such thin cells with a liquid solution between the electrodes and a liquid solution has disadvantages in this sort of application, a polymer proton-selective conducting membrane of the present invention is very suitable for batteries and capacitors in such applications.

Examples of applications of fuel cells of the type of this invention include cellular telephones, holsters for charging cellular phones, hand held and palm computers, portable computers, video cameras, still cameras, and digital cameras. In such applications the fuel cell should be small so as to be compatible with the size of the device and should operate at room temperature or at most a temperature of about 100° C. maximum, and preferably much less than 100° C. Such fuel cells are sometimes referred to as miniature fuel cells.

Other examples of applications of double-layer capacitors and pseudo-capacitors of the type of this invention include, but are not limited to, cellular phones, speakers for audio and stereo equipment, computers, cameras, and/or other devices that require pulse currents.

As used herein in the specification and in the claims section that follows, the term “compatibility”, with respect to the components of a membrane barrier refers to interactions between components, and/or phases, which produce a consolidated membrane. Thus the inventive membranes may contain miscible, almost miscible or non-miscible blends of two or more polymers.

As used herein in the specification and in the claims section that follows, the term “selectively proton-conducting membrane” refers to a membrane having a microstructure that enables the transport of protons to a significantly greater extent than the transport of a member from one or more of the following groups: cations other than protons, anions, neutral species, and gaseous species.

As used herein in the specification and in the claims section that follows, the term “consolidated membrane” refers to a dense, low porosity membrane that substantially obstructs convective flow and/or flow through large and/or non-selective pores.

Preferably, less than 10% of the surface of such a membrane contains pores in which convective flow can occur. More preferably, less than 5%, and most preferably, less than 1% of the surface contains pores in which convective flow can occur.

As used herein in the specification and in the claims section that follows, “PVDF” refers to polyvinylidene fluoride; “PVP” refers to polyvinylpyrrolidone; “HFP” refers to hexafluoropropylene.

As used herein in the specification and in the claims section that follows, the term “anion exchange membrane” refers to a proton-conducting anion exchange membrane.

As used herein in the specification and in the claims section that follows, percentages and ratios of components refer to weight percent and weight ratio, respectively.

The homogeneity of the blended components of the inventive membrane refers to the uniformity of distribution of the components. A homogeneous blend has a substantially uniform distribution. The blended components may include monomers, oligomers, polymers, poly aggregates and complexes, colloidal particles, submicronic particles and micronic particles and mixtures of two or more of the above.

Thus the invented membranes may be described as a homogenous blend of compatible components that form a thin, consolidated (dense), selective, proton conducting barrier that effectively reduces or eliminates convective flow.

In addition, the inventive membranes are made of polymer blends including at least one hydrophobic matrix polymer and at least one polar non-ionic polymer that exhibits proton conductivity. The concentration of the proton conducting polymer and its distribution within the matrix must be such that the proton conducting polymers form channels of conductivity connecting both surfaces of the membrane. In addition to being proton conducting, the homogeneity and density of the membranes provide excellent mechanical strength, which is required for various applications.

The consolidated structure of the membrane promotes the selective transport of protons as compared to other ions, solvents and gases. Porosity that enables convective transport greatly reduces any innate material selectivity.

The use of water soluble or miscible polymers with hydrophobic matrix materials such as polysulfone, polyether sulfone, polyvinylidine fluoride is well known in the state of art for making microfiltration and ultrafiltration membranes and as coatings on top of ultrafiltration supports to make nanofiltration (NF) and reverse osmosis (RO) membranes. In the making of microfiltration (MF) and ultrafiltration (UF) membranes, the water miscible polymer, for example polyvinylpyrrolidone (PVP), is added to a solution of the matrix polymer, for example polysulfone (PSu) in a common solvent such as DMF (dimethylformamide) or NMP (N-methyl-2-pyrrolidone). The PVP is compatible with the PSu in the solution and serves to increase the viscosity of the solution. Upon casting a wet film on a substrate or extruding a hollow fiber, the membrane is immersed in an aqueous solution to form a porous structure and to leach out most of the water soluble polymer. Part of the water soluble polymer remains and it may be cross-linked by a heat treatment or by reagents, making the membrane more hydrophilic.

Water soluble polymers can be cross-linked on the surface of ultrafiltration or microporous supports and used to make pressure-driven membranes such as RO or NF membranes. Such cross-linked water soluble polymers act as selective barriers between salts, organic substances and water, and may also act as anti-fouling layers.

By sharp contrast, the membranes of the present invention are dense and substantially non-porous membranes used in electrochemical processes wherein the convective transport is substantially reduced or eliminated. This appreciably contributes to the selectivity of the proton conduction.

Another aspect of the selectivity relates to the interaction between the components of the invented membrane. The membrane microstructure is designed and configured to produce various interactions between the hydrophilic and hydrophobic polymers and their respective functional groups, such that proton conduction is relatively enhanced by reducing the conduction of various other species (cations other than protons, anions, neutral species, gaseous species, and specific sub-groups thereof).

It has been discovered that the polymer matrix and the proton conducting polymers form adducts through their interactions. These adducts may be present over a range of composition and concentration in the inventive membrane as a function of the ratio of the matrix polymer to the proton conducting polymer. Thus, the inventive membrane is not a simple combination of the components, but rather a mixture of the components (sometimes including additional components) whose microstructure has been strongly determined by, inter alia, an interaction of the matrix and the proton-conducting polymer.

Without wishing to be limited by theoretical explanations of the required interactions of matrix component and the proton conducting polymers, it is believed that these interactions are manifest in various measurable physical properties of the inventive membrane material, including thermal, optical and mechanical properties, in addition to selective conductivity. The independent demonstration of interaction between the matrix and the conducting polymer, to form adducts of both components is shown below by thermal measurements and/or optical appearance of the invented membranes.

In one preferred class, the membranes include a matrix of PVDF or PVDF copolymers (e.g., polyvinylidene fluoride -co-hexafluoropropylene) with a water soluble polymer containing amide (e.g., poly(2-ethyl-2-oxazoline) or lactam groups (polyvinylpyrrolidone [PVP]).

One preferred example of the above class includes a membrane of PVDF and PVP. The presence of interactive adducts between PVDF and PVP is identified by measuring the change in the crystalline melting point of PVDF [Tₘ] by differential scanning DSC. A peak at about 174C characterizes the Tₘ of PVDF, and this is taken as the melting point of the crystalline portions (J. Mijovic, H-L Luoe, and C. D. Han, Polymer Engineering and Science, March 1982, Vol 22, No 4.).

We have made a series of membranes with varying weight ratios of PVDF/PVP [including 100/0, 90/10, 70/30, 50/50 and 30/70]. For the membrane comprising only PVPF without PVP, a sharp intense peak occurred in the differential scanning calorimetry (DSC) measurement at 175.7° C., which is the melting point (Tₘ) of PVDF. With increasing amounts of PVP, this peak is shifted to lower melting points. For example, at a PVDF/PVP ratio of 90/10, the melting point is 172C, for 70/30 the melting point peak at 173.8° C. is very small and a new peak appears at 161.5° C. For ratios of 50/50 and 30/70, the peak at 173° C. and the peak at 161.5° C. disappear completely and a major peak at 144° C. is left. The initial shifting and the complete disappearance of the peak representing the melting point of PVDF as a function of increasing PVP is indicative of interactions between the PVDF and the PVP. These interactions can also be seen in the changing light transmission properties of the membrane as a function of PVDF/PVP ratios. The PVDF film cast from NMP is translucent. In going from a composition of 70/30 to 50/50 and 30/70, the membranes become increasingly clear, such that the latter two are completely clear. The changing optical clarity may be attributed to the formation of adducts between the PVP and PVDF which reduces the polycrystalline nature of the latter.

The aforementioned interactions form an adduct between PVDF and PVP to which are attributed the excellent functionality of the invented membrane. The concentration of the adduct and its composition vary as a function of the ratio of PVDF to PVP. Included within this invention are membranes having a range of concentrations and adduct compositions. For example, in the case of a thin battery requiring a high selectivity, a ratio of PVDF/PVP of 70/30 may be preferred. For a thin electrolytic carbon capacitor, however, a higher proton conductivity and a lower selectivity are needed, such that the interactive adduct compositions and concentrations corresponding to a PVDF/PVP ratio of 50/50 can be used.

Membranes of water-soluble hydrophilic proton conducting polymers or water swellable polymers, by themselves are not sufficiently selective and in most cases do not have sufficient mechanical strength. In the sense that such membranes are also easily swollen, reducing the density of conductive groups, their conductivity is also relatively low. Moreover, membranes of multiphase polymer blends of such hydrophilic polymers with a hydrophobic matrix in which there is poor interface compatibility between the separate phases will be porous and have poor selectivity.

To have the necessary compatibility, the components should have attractive interactions between their segments, such as H-bonding, electrostatic interactions, pi orbital interactions, dipole-dipole interactions, dipole induced dipole interactions or charge transfer interactions. In random copolymers blended with either a homopolymer or a second random copolymer, a mechanism other than specific interaction may also lead to miscible interactions of the different polymers, e.g., a mutual repulsion force between the dissimilar segments in the copolymer that is sufficient to overcome the repulsion between these segments and those in the other polymer component(s) of the mixture.

The interactions between the polymers may lead to miscibility and a single phase or, if two or more phase occurs these interactions bring about interface compatibility. The interaction between the polymers also allows for the formation of network structures or connected structures (needed for conductivity) rather than isolated islands of one phase inside the other.

It should be emphasized that a given polymer combination of this invention may be miscible or non-miscible as a function of temperature, the method of preparation or the nature of the solvent used in the preparation, molecular weight and molecular weight distribution of the polymers, and presence of trace amounts of solvent or nonsolvent adsorbed during the application.

Both miscible and non-miscible blends may demonstrate the required properties of proton conductivity, selectivity and mechanical strength for one or more applications, though for any given application, one may be preferred over the other. For example, in a super capacitor, a homogenous non-miscible blend may be preferred because of the high conductivity requirement, while in a battery application the homogenous miscible blend may be preferred because of the high selectivity requirement.

The principles and operation of solid electrolyte membranes according to the present invention, and of various inventive electrochemical systems that utilize such membranes, can be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

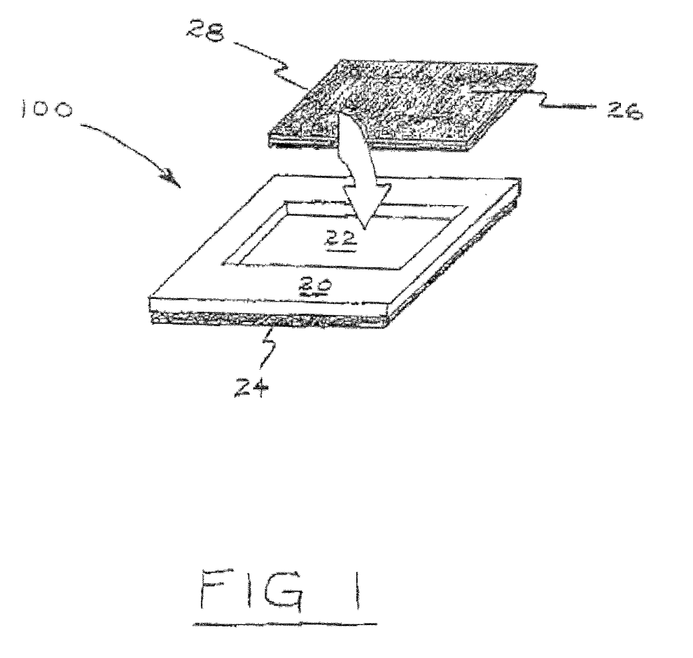

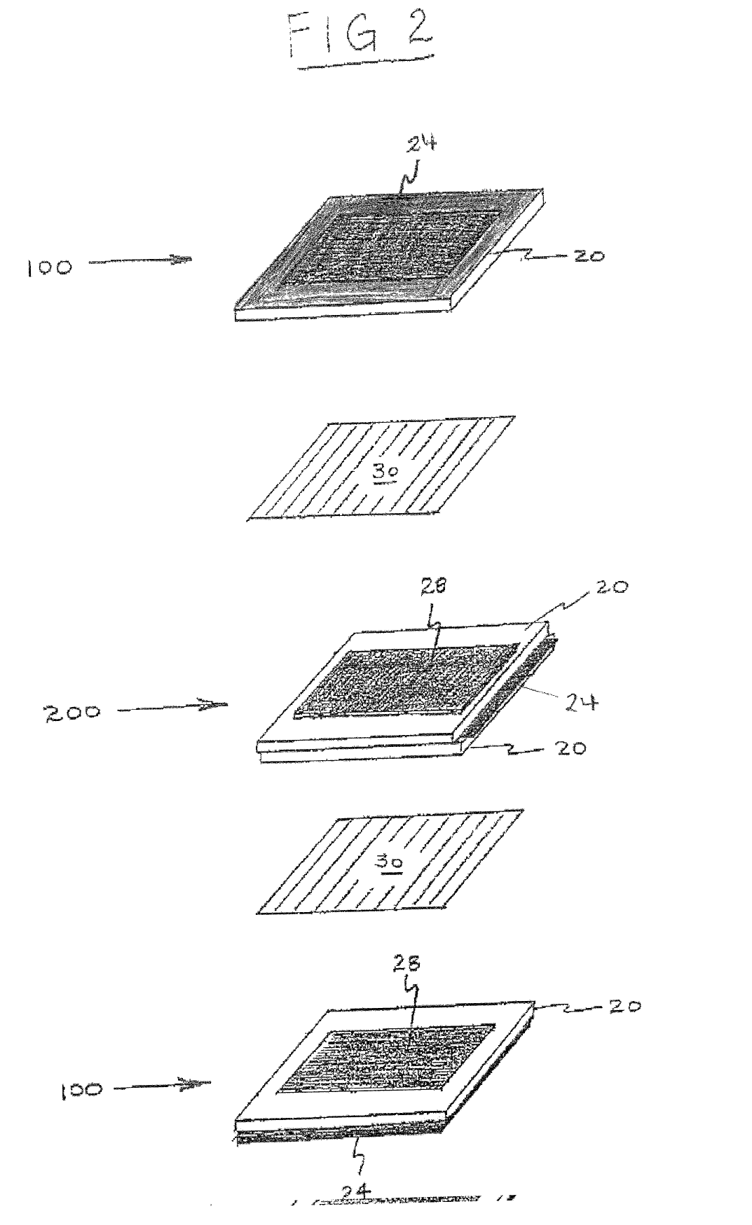

Referring now to the drawings, FIG. 1 is an illustration of a sub-assembly of an electrochemical double layer capacitor utilizing a membrane of the present invention. FIG. 1 depicts a non-conductive perforated isolating frame 20, which forms a cavity for the electrode. Frame 20 allows for a bipolar stack or a single cell sub-assembly 100 to be built. Frame 20 may be generally rectangular or square or of various other shapes. Also depicted in FIG. 1 is a current collector 24. The outer casing of this assembly functions as the current collector/external terminal of the device. A high surface area carbon-based paste 26 is preferably disposed in openings 22 within frame 20. Such a paste may form electrode plate 28. The membrane of the present invention, which functions to transport protons during operation of the capacitor is situated between the sub-assemblies of the electrochemical double layer capacitor, as shown in FIG. 2 below.

FIG. 2 depicts a multi-celled electrochemical double layer capacitor as formed by utilizing two sub-assemblies 100 of the type described in FIG. 1 (note, however, that sub-assembly 100 at the top of the multiple cell is disposed in mirror-image fashion to sub-assembly 100 at the bottom of the multiple cell). The two sub-assemblies 100 are combined with a bi-polar assembly 200 (having two frames 20, each having a cavity for an electrode plate 28, and wherein frames 20 are separated by a current collector 24) by stacking assemblies 100, 200 and 100, and separating them with proton conductive membranes 30.

Higher voltages can be obtained by inserting additional units of bipolar assembly 200 within the stack, according to the known art.

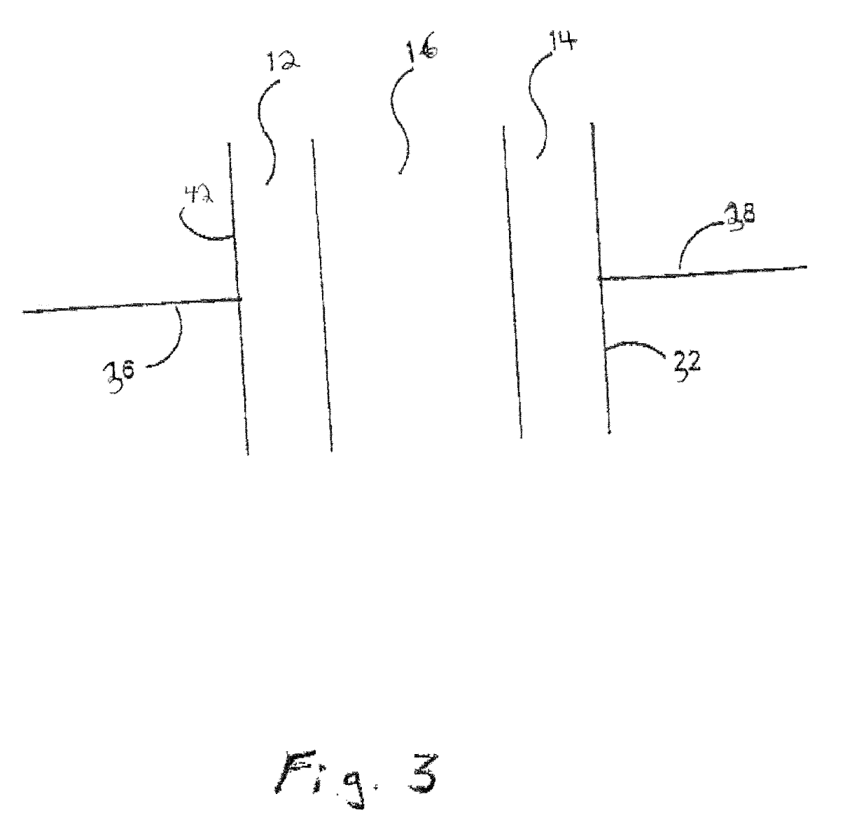

In FIG. 3 is provided a schematic, cross-sectional view of a battery utilizing a membrane according to the present invention. The battery includes an anode 12, a cathode 14 and an inventive, proton-selective conducting membrane 16, as well as a pair of leads 36 and 38. Optionally, the battery includes a pair of conducting plates 42 and 32.

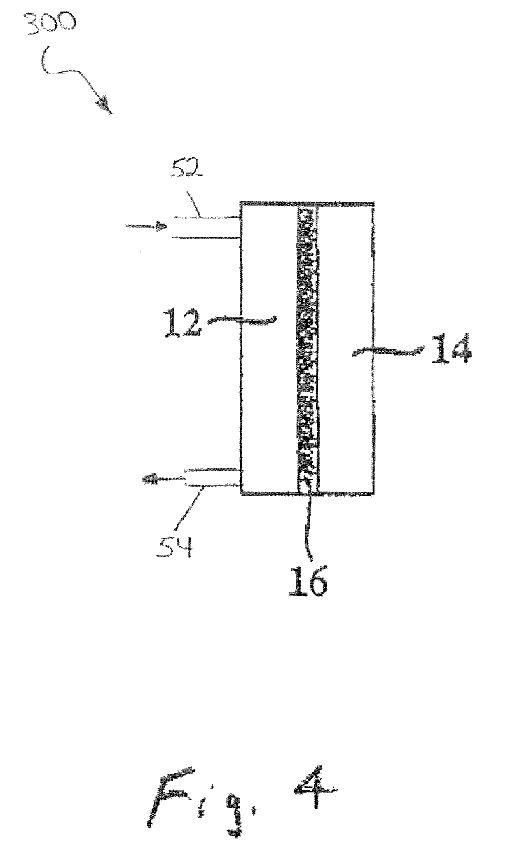

FIG. 4 illustrates basic components of a fuel cell 300 utilizing a membrane according to the present invention. Fuel cell 300 includes a fuel inlet 52 and outlet 54, an anode plate 12, a cathode plate 14 and a proton-selective conducting membrane 16 interposed between anode plate 12 and cathode plate 14, wherein an electrical contact is formed between anode plate 12 and cathode plate 14 via proton-selective conducting membrane 16, such that protons flow therebetween. Cathode plate 14 is exposed to air, or is supplied with oxygen, according to the known art.

In a preferred embodiment, the membranes of the present invention are made by dissolving two or more polymers in a common solvent, casting on a substrate, and evaporating or removing the solvent. In this way a homogeneous single phase membrane can be formed.

Alternatively, a homogenous biphase or multiphase membrane may be made by the aforementioned method. In this case of biphase or multiphase formation, the resultant membrane upon evaporation or solvent removal depends on the mechanism by which polymer-polymer solutions phase separate on crossing their critical solution temperatures or compositions. Phase separations may also continue in the finished membrane if the temperature is increased or if solvent are adsorbed from the environment.

Two types of phase separation are known and may occur in the invented membranes: nucleation and growth and spinodal decomposition. Nucleation and growth is where a nucleus of a phase forms and grows larger with time.. In the spinodal decomposition mechanism the size of the phase remains constant, but the composition changes with time. Frequently in spinodal phase formation the phases exhibit a high level of interconnectivity with a regular spacing between the domains, sometimes called the system wavelength. Both mechanisms (nucleation and growth, spinodal decomposition) may be observed in a single membrane system. The nucleation and growth occurs first and then switches over to spinodal decomposition as the system goes deeper into the phase separation region of the phase diagram.

Within the range of inventive membranes, the presence of one or more phases may be controlled or changed by the following:

the relative concentration of polymer components

the molecular weight of the components

the solvent used

the conditions of evaporation or solvent removal (e.g., temperature, relative humidity or other gas vapor, rate of evaporation)

the addition of plasticizers

the presence of residual solvents or solvent taken up under the conditions of use

“Windows of miscibility” may occur in polymer blends by different interaction mechanisms and the copolymer effect. When miscibility of polymers occurs, it is often sensitive to changes in chemical composition temperature, solvents, trace amounts of solvent impurities and molecular weight and molecular weight distribution. For example, the range of concentration and temperatures where polymer blends are miscible [called miscibility windows] increase substantially as the degree of polymerization is lowered. Or when specific interactions are present, as in the case for most miscible homopolymer blends, the presence of trace amounts of low molecular weight polar impurities, can significantly alter segmental interactions and phase separation.

### Methods of Forming Proton Conducting Films From A Polymer Matrix Material And A Proton Conducting Polymer

Many methods of combining polymer components together to form a film are known in the art. Many methods of combining the monomer unit of the desired polymer component together to form a film are also known from the art.

The following are provided as non-limiting examples:

The two polymer components can be mixed in a common solvent. The mixing is followed by casting and evaporating the solvent. A preferred procedure is to dissolve the polymer components (e.g., 66% Polyvinylidene fluoride and 34% polyvinyl pyrollidinone) in a common solvent such as N-methyl pyrrolidinone. The solution is casted on a substrate such as glass, polycarbonate, or a metal band. The solvent is evaporated in a convection oven between 70° C. to 90° C. for several hours. After cooling, the membrane is removed from the substrate by direct mechanical removal, or by immersion in a liquid such as water for a short period followed by collecting the membrane as it comes off the support. The membranes may be made in a batch or continuous method. To shorten the time for solvent removal during a continuous process, the membrane may be cast on a moving substrate and passed through one or more ovens operating at a temperature of 100° C. and above, in which the top of the substrate is heated. Optionally, the underside of the substrate is also heated.

Alternatively, the two polymer components may be coextruded as a melt, with or without plasticizers.

It is also possible to use particles of these materials, cross-linked, partially cross-linked, or non-cross-linked, instead of the polymer. Such particles are added to the matrix in a sufficiently high concentration that proton conductive channels are formed, but at the same time, excluding cations, anions and non-charged molecules. Such particles may range in size from nanometer particles to about 100 microns. These particles may be made by any of the well-known procedures or are commercially available from such commercial sources as Rohm and Haas®, Dow®, Bayer®, etc. The particles may be purchased at one size range and reduced in size by a variety of well known techniques.

Yet another method is to introduce the monomer of the polymer that will form the conducting polymer by swelling it in a film of the matrix materials either alone or in a solvent, and polymerizing it, or optionally cross-linking, by any of the procedures known in the art. Variations of this method can be used to form interpenetrating networks of the proton conducting polymer in the hydrophobic matrix.

In yet another method, monomers which do not readily copolymerize under the conditions of polymerization are mixed and polymerized as a film. One of the monomers forms the hydrophobic matrix, and the other monomer forms the polymer or polymers having the proton conductivity. In a variation of this approach, there may be some degree of copolymerization as well.

In another variation of the above approach, films of hydrophobic polymers (cross-linked and non-cross-linked) act as the matrix and the proton conducting groups are chemically bound to the matrix. This may be carried out by graft polymerization on polymer films swollen by the monomer by chemical redox sources, radiation ( alpha, beta and gamma sources), and UV (with and without sensitizers and with and without absorbers). In one preferred method, the film is swollen in a solvent, irradiated with a cobalt radiation source, removed, washed and immersed in a monomer to effect graft polymerization, washed of non-reacted monomer, and further reacted if needed to introduce amino or reactive groups. The polymer films chosen for grafting may be chosen from hydrocarbon polyolefins (for example polyethylene, polypropylene and their co and tri-polymers), fluorinated polyolefins (for example polytetrafluoroethylene, polyvinylidene fluoride, and their co and tri polymers, especially with chlorotrifluoroethylene, and hexafluoropropylene), or co or tri or ter polymers with fluorinated and non-fluorinated monomer units.

The materials and process for making the proton selective layer may be chosen from those described herein for the case of a single layer membrane. A composite of the proton selective layer on a microporous or ultrafiltration (UF) support may be done by many of the coating processes known to the state of art. For example, a solution of the proton conducting polymer with the matrix polymer may be cast onto the porous support by dip, kiss, and gravure coating or any other method known to the state of art. The solvent may be removed as discussed above but in this case the dense proton selective membrane is left on the porous support.

The microporous supports, which have pore sizes within the range of 0.1-10 microns, may be isotropic or asymmetric and may be made of organic polymeric, inorganic polymeric, metal, ceramic or inorganic matter and combinations of such materials. Typical organic materials are engineering plastics such as polysulfone, polyethersulfones, polyetherketones and polyetheretherketones, polyamides, polycarbonates, polyolefins, polytetrafluoroethylene (Teflon®), perflorinated or partially fluorinated polymers such as polyvinylidine fluroride and its copolymers. Sintered metals may be iron, steel, nickel, etc. Inorganic materials may be sintered alpha and gamma alumina, zirconium oxide, titanium oxide, and combinations may by sintering one material of a given particle size to form the support and then sintering on the surface smaller particles of the same or different materials to form an asymmetric membrane. Polyolefin membranes, which include polyethylene, polypropylene and their copolymers, polytetrafluoroethylene and its copolymers, and polyvinylidene fluoride and its co-polymers, are generally isotropic, and may be formed by sintering of particles, by stretch cracking homogeneous films, or by solvent casting and phase inversion in a nonsolvent, or by evaporation.

The UF supports, which have pore sizes within the range of 0.005-0.1 microns, are generally asymmetric and are made of polymeric materials by the phase inversion method. Inorganic or ceramic UF supports may be made by sintering large particles of a material and coating the surface with smaller particles or by sol-gel methods and sintering. This procedure may be repeated any number of times with progressively smaller particles to get tighter UF membranes. Typical organic materials are engineering plastics such as polysulfone, polyethersulfones, polyetherketones and polyetheretherketones, polyamides, polycarbonates, polyolefines, and polytetrafluoroethylene (Teflon®). Perflorinated or partially fluorinated polymers such as polyvinylidine fluroride and its copolymers. Combinations of organic inorganic polymers such as polyphosphazenes and polysiloxanes may be used. Sintered metals may be iron, steel, nickel,etc. Inorganics may be sintered alpha and gamma alumina, zirconium oxide, titanium oxide, and combinations thereof.

The proton selective membrane may then be coated on one side of the dense membrane or both sides of the dense membrane. Alternatively a sandwich of the dense membrane with the invented membrane in the middle may be made. In the case of the sandwich arrangement the dense membranes may be of the same type or may be of another type; thus the following combinations are included in the invention: (1) cation exchange-PEM of the invention-cation exchange; (2) anion exchange-PEM of the invention-cation exchange; (3) anion exchange-PEM of the invention-anion exchange; (4) ionically neutral cation-PEM of the invention-cation exchange; and (5) ionically neutral-PEM of the invention-anion exchange.

### Anion Exchange Layer

The material for the anion exchange layer may be a derivative of, for example, a quaternary ammonium group. These include quaternized derivatives of the following polymers: quaternized polyallyl amines, poly(alkyl oxazolines), for example, poly(2-ethyl-2-oxazoline, and their acid and base hydrolysis products, branched or linear quaternized polyethylene imine, quaternized polyvinyl amines and their copolymers such as poly (vinyl amine-co-vinyl alcohol), polyimidazoles, polybenzimidazoles, polyallylamines and quaternized amino derivatives of polysulfone, polyether sulfone, polyphenylene sulfone, polyetherketone, polyether-ether ketone, polyetherketone-ether ketone, and other variations of polyether ketones and polysulfones. Other materials are quaternized derivatives of polyphenylene sulfide, polyphenylene sulfide, phenylene sulfone and variations of sulfide and sulfone in the same polymer. Yet other materials are quaternized polyethers based on polyphenylene oxide such as 2,6 dimethyl phenylene oxide, in which the quaternization is on the aromatic or methyl group. Yet other materials are aromatic polyether imides, polyether imide-amide, aromatic polyamides and aromatic aliphatic polyamide combinations, polyethylenes, polypropylenes, polystyrenes and copolymers. Yet other materials are polyamides with quaternized groups in the main chain for example polyadipic acid-diethyl triamine, or as pendants. Yet other materials are quaternized derivatives of the halo-alkyl aromatic derivatives.

A material for the anion exchange layer may also be made by the addition of the above quaternary polymers, or with other anion exchange groups, to a matrix polymer in a common solvent, followed by casting and then drying. Alternatively, the quaternized-containing polymer may be co-extruded from a hot melt. In yet another embodiment a matrix polymer is mixed by the methods known in the art with an anion exchange polymer. In another embodiment anion exchange particles that are either cross-linked, partially cross-linked or non-cross-linked, are used instead of the polymer. The particles are added to such a sufficiently high concentration that anion exchange channels are formed. Such particles may range in size from about one nanometer to 100 microns. These particles may be made by any of the well-known procedures or are commercially available from such sources as Rohm and Haas®, Dow®, and Bayer®. The particles may be purchased in one size range and reduced in size by a variety of well known techniques.

In yet another embodiment of this invention the anion exchange membrane is based on a commercially available homogeneous anion exchange membrane such as one that available from Asahi®, Tokiyama Soda®, Ionics®, RAI®, Solvay®, US Filter® and Fumatec®. The methods of making such membranes include the polymerization of monomer units that form the matrix, monomers containing cation exchange groups for conferring anion exchange properties on the finished membrane, and cross-linking monomers. An example of such an approach is the combination of styrene, an amino quaternary ammonium derivatives of halomethylated styrene, and divinyl benzene. An alternative approach is to introduce the amino or quaternary ammonium group after the polymerization step of the matrix monomer. The monomer containing the reactive groups to form the amino or quaternary ammonium groups is then reacted after the matrix has been formed and cross-linked. A third approach is the polymerization of a matrix monomer and cross-linker and then reacting a portion of the matrix polymer of the finished membrane to form an anion exchange membrane. An example is the polymerization of styrene and divinyl benzene in a membrane configuration, reacting the membrane with chloro-methyl-methylether and stannic chloride in methylene chloride to form on a portion of the styrene group chloromethyl moieties, and then reacting with trimethylamine to form quaternary ammonium groups.

Still another embodiment for making homogeneous anion exchange membranes is by graft polymerization on polymer films by radiation, such as alpha, beta and gamma sources, and UV, with and without sensitizers and absorbers. In one preferred method the film is swollen in a solvent, irradiated with a cobalt source, removed, washed and immersed in a monomer to effect graft polymerization, washed of non-reacted monomer, and further reacted if needed to introduce amino or reactive groups. The polymer films chosen for grafting may be chosen from hydrocarbon polyolefins, for example polyethylene, polypropylene and their co-, tri- and tetra- polymers, fluorinated polyolefins, for example polytetrafluoroethylene, polyvinylidene fluoride, and their co-, tri-, and tetra- polymers especially with chlorotrifluoroethylene, and hexafluoropropylene. Examples of preferred monomers are styrene, halomethylated styrene, polyallyl amine, and diallylamine.

### Cation Exchange Layer

The material for the cation exchange layer has anionic groups such as, but not limited to, sulfonic, sulfinic, phosphonic, or carboxylic acid groups. Such polymers may be sulfonic, sulfinic, phosphonic, or carboxylic acid derivatives of the following polymer classes:

Polyimidazoles, polybenzimidazoles;

Derivatives of polysulfone, polyether sulfone, polyphenylene sulfone, polyetherketone, polyether-ether ketone, polyetherketone-etherketone, and other variations of polyether ketones and polysulfones, polyphenylene sulfide, polyphenylene sulfide, phenylene sulfone and variations of sulfide and sulfone in the same polymer;

Polyethers based on polyphenylene oxide such as, but not limited to, 2,6 dimethyl phenylene oxide where the quaternization is on the aromatic or methyl group. Aromatic polyether imides, polyether imide-amide, aromatic polyamides and aromatic aliphatic polyamide combinations;

Derivatives of polyethylenes, polypropylenes, polystyrenes and copolymers of these materials;

Polyamides with anionic side groups in the main chain;

Sulfonated, phosphonated and carboxylated polyvinylidene fluoride homo and copolymers and other fluorinated polymers with active hydrogens which can be substituted with sulfonic, phosphonic and carboxyl groups.

The cation exchange membranes may be based on commercially available homogeneous anion exchange membranes such as those of Asahi®, Tokiyama Soda®, Ionics®, RAIT, Solvay®, US Filter® and Fumatec®. The methods of making such membranes include the polymerization of monomer units that form the matrix, monomers containing anion exchange groups for conferring cation exchange properties on the finished membrane, and crosslinking monomers. An example of such an approach is the polymerization combination of styrene, and divinyl benzene, followed by sulfonation. An alternative approach would be to polymerize a monomer with the anionic group together with other monomers and crosslinkers. A third approach would be the polymerization of a matrix monomer and cross-linker and then reacting a portion of the matrix polymer of the finished membrane to form a cation exchange membrane.

Commercial cation perfluorinated membranes can also be used based on the following polymer:

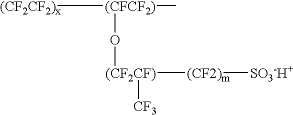

Such membranes are manufactured and/or supplied by DuPont®, Dow®, Asahi®, W.L. Gore and Associates®, Solution Technologies Incorporated®, and Chlorine Engineers Japan®.

### Neutral Membrane Layer

These dense layers may act as supports without selectivity to protons but with nevertheless high proton conductivity. Examples of such materials are polyvinylalcohol and its co-, ter- and tetra- polymers, and derivatives such as polyvinylmethoxyacetal, polyvinyl methyl ethers, and their perfluorinated derivatives, cellulose and cellulosic derivatives such as methyl, ethyl, hydroxyethyl, hydroxypropyl, ethylhydroxyethyl, ethylmethyl, hydroxybutylmethyl, hydroxyethylmethyl, hydroxypropylmethyl, starch and starch derivatives, polyethylene and polypropylene oxide and polyvinylmethyl and ethyl ethers and their derivatives, especially perfluorinated derivatives.

A list of preferred materials for producing the membranes of the present invention is provided below, including preferred molecular weight ranges. The list also includes the compositions of a few presently preferred membranes.

### Matrix

Presently preferred matrix materials include: polysulfone, polyphenylene oxide, polystyrene, polyethersulfone, PVDF, and PVDF-HFP. Each can be used within a wide range of molecular weights.

The most preferred matrix materials are PVDF, and PVDF-HFP. Each can be used within a wide range of molecular weights. PVDF can be used with molecular weights in the preferred range of 40,000 to 160,000. An even more preferred range is between 85,000 to 120,000. PVDF-HFP can be used with molecular weights in the preferred range of 100,000 to 160,000, and in a more preferred range of 120,000 to 140,000.

Presently preferred active materials include: PVP, hydrolyzed PVP, polyvinylpyridine (PVPyr), poly(2-ethyl-2-oxazoline) (PEOZ), and hydrolyzed PEOZ. Each can be used in a wide range of molecular weights. Combinations of these active materials can also be used.

The most preferred active material is PVP. can be used in a variety of molecular weights ranging between 1,000 and 2,000,000. Preferably, the material is of high molecular weight in the range of 360,000 to 1,500,000, and even more preferably, the molecular weight is in the range of 900,000 to 1,500,000.

### Membrane

Preferred membranes combine the preferred matrix materials with the preferred active materials. The percent composition refers to weight percent of the components.

The preferred range of ratios is 20-80% matrix material with the remainder consisting of active material.

A more specific ratio for battery applications is 47%-77% matrix material with the corresponding % active material (23%-53%), and more preferably, 57%-67% matrix material with the corresponding % active material (33%-43%).

A more specific ratio for capacitor applications is 23%-53% matrix material with the corresponding % active material (47%- 77%), and more preferably, 25%-33% matrix material with the corresponding % active material (67%-75%).

The preferred membranes (matrix plus active) include PVDF/PVP and PVDF-HFP/PVP.

For batteries, the preferred ratio of the PVDF/PVP membrane is 57-67% PVDF with a molecular weight between 85,000 to 120,000/with a corresponding 43-33% PVP with molecular weight between 900,000 to 1,500,000.

For batteries the preferred ratio for the PVDF-HFP/PVP membrane is 57-67% PVDF-HFP with a molecular weight between 120,000 to 140,000, with a corresponding 43-33% PVP with molecular weight between 900,000 to 1,500,000.

For capacitors the preferred ratio of the PVDF/PVP membrane is 25-33% PVDF with a molecular weight between 85,000 to 120,000/with a corresponding 75-67% PVP with molecular weight between 360,000 to 1,500,000.

For capacitors the preferred ratio of the PVDF-HFP/PVP membrane is 25-33% PVDF-HFP with a molecular weight between 120,000 to 140,000/with a corresponding 75-67% PVP with molecular weight between 360,000 to 1,500,000.

### EXAMPLES

Reference is now made to the following examples, which together with the above descriptions, illustrate the invention in a non-limiting fashion.

### Example 1

Double layer capacitor energy storage components were constructed. The cell includes two electrodes separated by a proton conducting polymer membrane, each electrode having a thickness of about 0.3 mm, and terminal current collectors. The electrodes include a high surface area carbon powder and an aqueous solution of sulfuric acid. The terminal current collectors include a conductive carbon composite film of about 50 microns thickness. The membrane includes 62 w/o PSu and 38 w/o PVP and its thickness is about 40 microns. The internal resistance of such cells, as built, is about 2 ohms. The measured nominal capacity of the cells is 160 micro-amp hours.

### Example 2

Double layer capacitors were built as in Example 1. The membrane contains 57 w/o PSu and 43 w/o PVP and its thickness is about 50 microns. The internal resistance of such cells as built is about 1.5 ohms.

### Example 3

Rechargeable battery cells were constructed. The cell includes two electrodes of about 0.2 mm thickness each that are separated by a proton conducting polymer membrane, and terminal current collectors. The cathode electrode includes a carbon powder and an active material of manganese sulfate. The anode contains a carbon powder and a tin compound. The terminal current collectors include a conductive carbon composite film of about 50 microns thickness. Cells were built with the membrane compositions as described in the table below and were cycled at 4 mA constant current for the charge and for the discharge half-cycles. Discharge capacities were measured to a cut-off voltage of 1.15 volts. The nominal closed circuit voltage was 1.5 volts at this drain. The cross-sectional area of the electrodes was 1 square centimeter. (The cell series code is C578-NM-1-99-92.) Cells were cycled for about 50 cycles to demonstrate cyclability. The percent composition of the membrane in the table refers to weight per cent of the polymers. The prior art membrane is a commercial anion exchange membrane (ADP of Solvay®) tested on experiment M-53, cell series M585. The experiments were performed at ambient temperature.

| | | Cell Resistance of as built cells in |
|---|---|---|
| | Thickness, | discharged state before cycling, |
| Membrane | microns | ohms |
| PSu, 72%/PVP, 28% | 48 | 25.9 |
| PSu, 67%/PVP, 33% | 40 | 8.5 |
| PSu, 62%/PVP, 38% | 45 | 4.0 |
| PVDF, 67%/PVP, 33% | 58 | 1.8 |
| ADP (Solvay ®) | 100 | 22.4 |

| | Cycle 5, | Cycle 25, | Cycles to |
|---|---|---|---|
| Membrane | mAh Capacity | mAh Capacity | 2 mAH |
| PSu, 72%/PVP, 28% | 3.4 | 2.4 | 42 |
| PSu, 67%/PVP, 33% | 3.4 | 3 | 50 |
| PSu, 62%/PVP, 38% | 3.5 | 3.2 | 47 |
| PVDF, 67%/PVP, 33% | 3.5 | 3.4 | 48 |
| ADP (Solvay ®) | 3.6 | 3.6 | >35 |

### Example 4

Rechargeable battery cells were constructed. The cell includes two electrodes of about 0.2 mm thickness and separated by a either a single layer or a double layer of proton conducting polymer membrane (PVDF, 67%/PVP, 33%), and terminal current collectors. The cathode electrode includes a carbon powder and an active material of manganese sulfate. The anode includes a carbon powder and a tin compound. The terminal current collectors include a conductive carbon composite film of about 50 microns thickness. Cells were built with the membrane compositions as described in the table below and were cycled at 4 mA constant current for the charge and for the discharge half-cycles. Discharge capacities were measured to a cut-off voltage of 1.15 volts. The nominal closed circuit voltage was 1.5 volts at this drain. The cross-sectional area of the electrodes was 4 square centimeters. Cells were cycled for about 90 cycles to demonstrate cyclability. Coulombic efficiency is calculated by dividing the discharge capacity by the charge capacity. Self-discharge is calculated from the capacity delivered in the discharge at the end of the rest period as compared to the discharge capacity of the cycle immediately preceding the rest period.

| | | Coulombic | % Self-Discharge per day |
|---|---|---|---|
| Membrane | | Efficiency, | during a 24 hour rest at |
| Layers | Expt. # | % | room temperature |
| 1 | SC-143 | 98% | 2.4% |
| 2 | SC-144 | 98% | 1.9% |
| 1 | SC-145 | 90% | 1.2% |
| 2 | SC-146 | 99% | 1.9% |

### Example 5

Rechargeable battery cells were constructed. The cell includes two electrodes of about 0.2 mm thickness each that are separated by a proton conducting polymer membrane, and terminal current collectors. The cathode electrode includes a carbon powder and an active material of manganese sulfate. The anode contains a carbon powder and a material that includes a tin compound. The terminal current collectors include a conductive carbon composite film of about 50 microns thickness. Cells were built with the membrane compositions as described in the table below and were cycled at 4 mA constant current for the charge and for the discharge half-cycles. The commercial anion exchange membrane is ADP of Solvay®. Discharge capacities were measured to a cut-off voltage of 1.15 volts. The nominal closed circuit voltage was 1.5 volts at this drain. The cross-sectional area of the electrodes was 4 square centimeters. Self-discharge is calculated from the capacity delivered in the discharge at the end of the rest period as compared to the discharge capacity of the cycle immediately preceding the rest period. The percent composition of the membrane refers to weight per cent of the polymers.

| | | | % Self-Discharge per |
|---|---|---|---|
| | Thickness | Expt. | day during a 24 hour |
| Membrane | (microns) | # | rest at room temperature |
| PVDF, 62%/ | 35 | 104/6 | 6.24 |
| PVP, 38% | | | |
| PES, 62%/ | 35 | 109/2 | 2.4% |
| PVP, 38% | | | |
| PES, 67%/ | 40 | 109/1 | 1.2% |
| PVP, 33% | | | |
| PES, 67%/ | 45 | 114/2 | 2.4% |
| PEOZ, 33% | | | |
| PVDF-HFP, 67%/ | 45 | — | 2.4% |
| PVP, 33% | | | |
| PVDF-HFP, 67%/ | 45 | — | 4.8% |
| Hydrolyzed | | | |
| PEOZ, 33% | | | |
| ADP (Solvay ®) | 100 | 121/1 | 12% |

The PVDF-HFP/PVP based membrane cycled for 250 cycles at greater than 96% coulombic efficiency. The PVDF/PVP based membrane, 104/6, cycled for 240 cycles at greater than 96% coulombic efficiency. The PVDF-HFP/hydrolyzed PEOZ based membrane cycled for more than 165 cycles with a coulombic efficiency between 95-100%.

Even though the commercial ion exchange membrane used in the cells was thicker than the membranes of this invention, it provided a worse self-discharge rate than the membranes of this invention. Thus, the improved performance of the various membranes of this invention is plainly evident.

### Example 6

Rechargeable battery cells were constructed. The cell includes two electrodes of about 0.2 mm thickness each, separated by a proton conducting polymer membrane (PVDF, 67%/ PVP, 33%), and terminal current collectors. The cathode electrode contains a carbon powder and an active material of manganese sulfate. The anode includes a carbon powder and a tin compound. The terminal current collectors include a conductive carbon composite film of about 50 microns thickness. The cross-sectional area of the electrodes was 4 square centimeters.

Cells were charged at various charging currents and discharged at 4 mA. A cycle consisted of charging at the indicated current and then discharging the cell. Three such cycles were repeated for each level of charging current and the average discharge capacity was calculated for data presentation. A subsequent set of cycles used a different charging current followed by discharge. Charge rates of between 1° C. and 8° C. were used. After the set of highest level of charging current, the 8° C. rate, was completed another set of cycles at the lowest charging current at the 1° C. rate was repeated. There was no difference in the cell discharge performance at the initial and final 1° C. rate charging current sets thereby indicating the viability and robustness of the cells under these test conditions. Discharge capacities were measured to a cut-off voltage of 1.15 volts.

Cells were discharged at various currents and charged at 4 mA. A cycle consisted of charging at the indicated current and then discharging the cell. Three such cycles were repeated for each level of discharge current and the average discharge capacity was calculated for data presentation. A subsequent set of cycles used a different discharge current. Discharge rates up to 8° C. were used. After the set of the highest level of discharging current, the 8° C. rate, was completed another set of cycles at the lowest discharging current was repeated. There was no difference in the cell discharge performance at the initial and final low rate discharging current sets thereby indicating the viability and robustness of the cells under these test conditions. Discharge capacities were measured to a cut-off voltage of 1.15 volts.

The very high discharge and charge rates of cells built with membranes made in accordance to this invention shows the high proton conductivity properties of these membranes.

Permeability of membranes of this invention to cations was measured. The membrane was placed in a fixture between two glass fiber paper sheets. One sheet was soaked with an aqueous sulfate solution containing Sn or Mn cations. The other sheet in the fixture was soaked with a sulfuric acid solution. The fixtures were stored under the storage conditions indicated in the table below. At the end of storage the concentration of the Sn or Mn that permeated across the membrane was measured by inductively coupled plasma (ICP) analysis. The results are given below. The low permeability to metal cations shows the high selectivity to protons of membranes made in accordance with this invention.

| | Storage | Sn | Mn |
|---|---|---|---|
| Membrane | Conditions | (ppm) | (ppm) |
| PVDF/PVP | 12 days @ RT | 5.5 | 1.7 |
| PVDF-HFP/PVP | 3 days @ 55 C | 2.8 | 5.8 |
| PES/PVP | 12 days @ RT | 0.3 | 0.1 |
| PES/PEOZ | 12 days @ RT | 0.1 | 0.1 |

The combination of features of very fast charge and discharge capability, 8° C. rate, of cells built with the membranes made in accordance with this invention (the current is carried by protons) and the low permeability of these membranes to metal cations, demonstrates both the high selectivity of these membranes to protons and their high proton conductivity. Thus the properties of high proton selectivity and high proton conductivity are combined into a single membrane according to this invention, in sharp contrast to the prior art.

### Example 7

Fuel cell energy conversion components were constructed. The cell includes two commercially available state-of-the-art catalyzed carbon electrodes (ELAT®, produced by E-Tek, Inc. of New Jersey, USA and having a platinum loading of 1 mg Pt per cm² of geometric surface area) separated by a proton conducting polymer membrane, and terminal current collectors. The membrane contains 67 w/o PVDF and 33 w/o PVP and its thickness is about 40 microns. The fuel cell thickness is about 0.6 mm. The electrode area is three square centimeters. The cathode feed was oxygen and the anode feed was hydrogen gas. The open circuit voltage was 800 mV. The cell was operated at ambient temperature. 150 mA of current was drawn from the fuel cell under load, at a voltage of about 0.5 volts.

### Example 8

A rechargeable battery cell was made and tested as in Example 4. The membrane was prepared as follows: a 15% solution of Durethan T40 (a nylon composed of hexamethylenediamine and isophthalic acid) in N-methylpyrrolidone is prepared. A layer of 100 microns thickness is cast on a glass plate and immersed in water, where it is kept for at least 24 hours, so that all the solvent will be removed. The plate is taken out of the water and while still wet the formed membrane is wetted with 4 M sulfuric acid on the porous side. Then it is folded, so that the porous side is on the inside and as such it is put into the cell. The cell performs entirely normal. In this case the matrix and the proton active material are of the same kind. By the phase inversion method an asymmetric membrane is formed that contains pores on one side which are selective to proton passage while at least partially rejecting other cations, anions, and some neutral molecules.

### Example 9

Two commercial state-of-the-art fuel cell electrodes as in Example 7 are painted with NMP on their active side and, while still wet with the NMP, the electrodes are placed onto both sides of a 30 micron thick membrane of this invention containing one third by weight of polyvinylpyrrolidone (MW 360,000) and two thirds by weight of polyvinylidene fluoride. This membrane/electrode assembly is pressed at one half ton per cm2 and heated under pressure at 70° C. for three hours. The thus obtained membrane/electrode/assembly is put in a simple hydrogen/oxygen fuel cell without pressurized gas. The fuel cell is operated at room temperature. Powers of 10 mW per cm2 can be sustained for days without a decrease in activity. This preliminary experiment shows that, in principle, these membranes can work in a fuel cell system with high power output.

### Example 10

A double layer capacitor cell is built from two electrodes consisting of activated carbon wetted with 3 M sulfuric acid. The electrodes are separated by a membrane of the present invention consisting of two thirds by weight of polyvinylpyrrolidone (molecular weight 360,000) and one third by weight PVDF-HFP copolymer (Solef 21508, produced by Solvay, molecular weight of 120,000). The membrane is 30 microns thick. The capacitor is charged and can be discharged at a current of 550 mA per cm2. This proves that the membrane can pass the amount of protons equivalent to this kind of currents without difficulty. The membrane was tested by studying the self-discharge in a redox system having it as a separator and no indications for mixing of phases was found and subsequently the high currents found above cannot be because of the presence of pinholes in the membrane.

### Example 11

Fuel cell energy conversion components were constructed as described in Example 9. The anode feed was a 5% aqueous methanol solution instead of hydrogen gas. A current of 15 mA/cm² was sustained at a cell voltage of 0.2 volts.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A membrane comprising:
(a) a hydrophobic matrix polymer and
(b) a hydrophilic non-ionic polymer, wherein said hydrophobic polymer and said hydrophilic polymer form together a selectively proton-conducting membrane.

2. The membrane of claim 1, wherein said hydrophobic polymer and said hydrophilic polymer are distributed in a substantially homogeneous blend.

3. The membrane of claim 1, wherein said hydrophobic polymer and said hydrophilic polymer organize into at least two phases.

4. The membrane of claim 1, wherein said hydrophobic polymer and said hydrophilic polymer organize into a miscible phase.

5. The membrane of claim 1, wherein said proton-conducting membrane includes a t least two non-miscible phases.

6. The membrane of claim I, wherein said selectively proton-conducting membrane is substantially a barrier to cationic species other than protons.

7. The membrane of claim 1, wherein said selectively proton-conducting membrane is substantially a barrier to anionic species.

8. The membrane of claim 1, wherein said selectively proton-conducting membrane is substantially a barrier to neutral species.

9. The membrane of claim 1, wherein said selectively proton-conducting membrane is substantially a barrier to gaseous species.

10. The membrane of claim 1, wherein said selectively proton-conducting membrane is substantially a barrier to organic species.

11. The membrane of claim 1, wherein said selectively proton-conducting membrane is substantially a barrier to anionic species, neutral species, gaseous species, organic species, and cationic species other than protons.

12. The membrane of claim 1, wherein said selectively proton-conducting membrane is substantially a barrier to water.

13. The membrane of claim 1, wherein said hydrophobic polymer includes a first functional group and wherein said hydrophilic polymer includes a second functional group, said first and second functional groups are configured by an interaction to form a conduit for the selective conduction of protons.

14. The membrane of claim 13, wherein said interaction is selected from the group consisting of H-bonding interactions, electrostatic interactions, pi orbital interactions, dipole-dipole interactions, dipole induced dipole interactions, charge transfer interactions and an interaction representing a sum of a mutual repulsive force between dissimilar segments within one of said polymers and a repulsive source between said polymers.

15. The membrane of claim 13, wherein said first functional group is selected from at least one of the groups consisting of halide, nitro, sulfone, nitrile, ether, carbonyl, benzyl, aromatic, and heterocyclic aromatic groups.

16. The membrane of claim 13, wherein said second functional group is selected from at least one of the groups consisting of amide, lactam, Shiff base, hydroxyl amine, ether, phosphonate, heterocyclic containing a cyclic nitrogen atom, heterocyclic containing a cyclic oxygen atom, and heterocyclic containing a cyclic sulfur atom.

17. The membrane of claim 1, wherein said hydrophobic matrix polymer is a fluoro-polymer selected from the group consisting of polymer, copolymer, and terpolymer.

18. The membrane of claim 1, wherein said hydrophilic polymer has at least one functional group selected from the group consisting of amides, lactams, and amines.

19. The membrane of claim 1, wherein said hydrophobic polymer is selected from the group consisting of polyvinylidene fluoride (PVDF), copolymers thereof, terpolymers thereof, polyphenylene oxide, polysulfone, polyether sulfone, polyphenyl sulfone, combinations thereof, and derivatives thereof.

20. The membrane of claim 1, wherein said hydrophilic polymer is selected from the group consisting of polyvinylpyrrolidone, copolymers of polyvinylpyrrolidone, poly (2-methyl-2-oxazoline) polymers, poly (2-ethyl-2-oxazoline) polymers, combinations thereof, and derivatives thereof.

21. The membrane of claim 1, wherein said hydrophobic polymer is selected from the group consisting of polyvinylidene fluoride and polyvinylidene fluoride co-hexafluoropropylene, and wherein said hydrophilic polymer is selected from the group consisting of polyvinylpyrrolidone and poly(2-ethyl-2-oxazoline).

22. The membrane of claim 1, further comprising:
(c) a porous support layer for supporting said selectively proton-conducting membrane.

23. The membrane of claim 1, wherein said selectively proton-conducting membrane is free-standing.

24. The membrane of claim 1, wherein said selectively proton-conducting membrane is a single membrane, said single membrane further comprising:
(c) an embedded net.

25. The membrane of claim 1, wherein said selectively proton-conducting membrane is a single membrane, said single membrane further comprising:
(c) a non-woven material.

26. The membrane of claim 1, wherein said selectively proton-conducting membrane is a single membrane, said single membrane further comprising:
(c) a randomly structured material.

27. The membrane of claim 1, wherein said selectively proton-conducting membrane is a layer in a composite membrane having a layer of a cation exchange membrane.

28. The membrane of claim 1, wherein said selectively proton-conducting membrane is a layer in a composite membrane having a layer of an anion exchange membrane.

29. The membrane of claim 27, wherein said composite membrane includes a layer of an anion exchange membrane.

30. A membrane comprising:
(a) a hydrophobic matrix polymer, and (b) a hydrophilic non-ionic polymer,
wherein said hydrophobic polymer and said hydrophilic polymer form together a consolidated selectively proton-conducting membrane.

31. An electrochemical system comprising:
an electrochemical cell including:
(a) an anode;
(b) a cathode, and
(c) a selectively proton-conducting membrane disposed between, and being in communication with, said anode and said cathode, said membrane containing:
(i) a hydrophobic matrix polymer and
(ii) a hydrophilic non-ionic polymer.

32. The electrochemical system of claim 31, said anode including at least one material having a metal whose cation can assume at least two different non-zero oxidation numbers, said cathode including a compound forming an electrochemical couple with said anode, and wherein said cell is inherently active in initiation of discharge under ambient conditions.

33. The electrochemical system of claim 31, wherein said anode includes an organic compound that is a source of protons during discharge, and wherein said cathode includes a compound which forms an electrochemical couple with said anode.

34. The electrochemical system according to claim 31, wherein said electrochemical cell is a fuel cell.

35. The electrochemical system according to claim 34, wherein an anodic fuel of said fuel cell is an organic liquid.

36. The electrochemical system according to claim 34, wherein an anodic fuel of said fuel cell is hydrogen.

37. The electrochemical system according to claim 31, wherein said anode forms a first layer, said cathode forms a second layer, and wherein said selectively proton-conducting membrane is structured as a layer in an integrated assembly, said assembly further including at least one of said first and second layers affixed to said membrane.

38. The electrochemical system according to claim 31, wherein said anode contains a compound of tin.

39. The electrochemical system according to claim 31, wherein said cathode contains a compound of manganese.

40. The electrochemical system according to claim 31, wherein said anode contains a compound of tin, and wherein said cathode contains a compound of manganese.

41. The electrochemical system according to claim 31, wherein said electrochemical cell is a rechargeable battery.

42. The electrochemical system according to claim 41, wherein said rechargeable battery has a thickness of about 0.2 mm to about 8 mm.

43. The electrochemical system according to claim 41, wherein each of said anode and said cathode have a thickness of about 30 microns to about 600 microns.

44. The electrochemical system according to claim 41, wherein said battery is disposed in a smart card.

45. The electrochemical system according to claim 41, wherein said battery is disposed in an RF tag.

46. The electrochemical system according to claim 31, wherein said electrochemical cell is an electrochemical double layer capacitor.

47. The electrochemical system according to claim 46, wherein said double layer capacitor has a plurality of electrodes, and wherein each of said electrodes has a thickness of about 30 microns to about 300 microns.

48. The electrochemical system according to claim 46, wherein said double layer capacitor has a plurality of electrodes, and wherein at least one of said electrodes includes a high surface area carbon material and a protonic medium, said protonic medium selected from the group of materials consisting of water, aqueous acid solutions, sulfonic acids, compounds having at least one alcohol group, and combinations thereof.

49. The electrochemical system according to claim 46, wherein said double layer capacitor has a thickness of about 0.2 mm to about 7 mm.

50. The electrochemical system according to claim 31, wherein said electrochemical cell is a p seudo-capacitor.

51. The electrochemical system according to claim 31, wherein said electrochemical cell is a non-rechargeable battery.

52. The electrochemical system according to claim 41, wherein said hydrophobic matrix polymer is PVDF, and said hydrophilic non-ionic polymer is PVP, and wherein said membrane contains between 57% and 67% PVDF, and between 33% and 43% PVP.

53. The electrochemical system according to claim 41, wherein said hydrophobic matrix polymer is PVDF, and said hydrophilic non-ionic polymer is PVP, and wherein said membrane contains a PVDF to PVP weight ratio of between 1.32 to 1 and 2.03 to 1.

54. The electrochemical system according to claim 41, wherein said hydrophobic matrix polymer is PVDF-HFP, and said hydrophilic non-ionic polymer is PVP, and wherein said membrane contains between 57% and 67% PVDF-HFP, and between 33% and 43% PVP.

55. The electrochemical system according to claim 41, wherein said hydrophobic matrix polymer is PVDF-HFP, and said hydrophilic non-ionic polymer is PVP, and wherein said membrane contains a PVDF-HFP to PVP weight ratio of between 1.32 to 1 and 2.03 to 1.

56. The electrochemical system according to claim 46, wherein said hydrophobic matrix polymer is PVDF, and said hydrophilic non-ionic polymer is PVP, and wherein said membrane contains between 25% and 33% PVDF, and between 67% and 75% PVP.

57. The electrochemical system according to claim 46, wherein said hydrophobic matrix polymer is PVDF, and said hydrophilic non-ionic polymer is PVP, and wherein said membrane contains a PVDF to PVP weight ratio of between 0.33 to I and 0.50 to 1.

58. The electrochemical system according to claim 46, wherein said hydrophobic matrix polymer is PVDF-HFP, and said hydrophilic non-ionic polymer is PVP, and wherein said membrane contains between 25% and 33% PVDF-HFP, and between 67% and 75% PVP.

59. The electrochemical system according to claim 46, wherein said hydrophobic matrix polymer is PVDF-HFP, and said hydrophilic non-ionic polymer is PVP, and wherein said membrane contains a PVDF-HFP to PVP weight ratio of between 0.33 to 1 and 0.50 to 1.

60. A method of operating an electrochemical cell, the method comprising the steps of:
(a) providing an electro chemical cell including:
an anode;
(ii) a cathode, and
(iii) a consolidated selectively proton-conducting membrane disposed between, and being in communication with, said anode and said cathode.
(b) transporting protons across said membrane, between said anode and said cathode, and
(c) substantially obstructing at least one species other than protons from passing through said membrane.

61. A method of producing a membrane, comprising the steps of:
(a) providing:
(i) a hydrophobic matrix polymer;
(ii) a hydrophilic non-ionic polymer, and
(iii) at least one common solvent for said hydrophobic matrix polymer and said hydrophilic non-ionic polymer;
(b) dissolving in said at least one common solvent, said hydrophobic matrix polymer and said hydrophilic non-ionic polymer, to produce a solution, and
(c) treating said solution to produce a consolidated selectively proton-conducting membrane.

62. The method of claim 61, wherein said treating includes:
(i) casting said solution on a substrate.
